(19) United States
(12) Patent Application Publication
(10) Pub. No.: US 2021/0091518 A1
(43) Pub. Date: Mar. 25, 2021

(54) COAXIAL CABLE CONNECTOR HAVING BRAID POSITIONING ELEMENTS AND F-TYPE FEMALE PORT WITH SNAP-IN FEATURES

(71) Applicant: CORNING OPTICAL COMMUNICATIONS RF LLC, GLENDALE, AZ (US)

(72) Inventors: Soren Baldus-Kunze, Slagelse (DK); Nikolaj Slobodziuk, Vordingborg (DK)

(21) Appl. No.: 17/027,689

(22) Filed: Sep. 21, 2020

Related U.S. Application Data
(60) Provisional application No. 62/994,642, filed on Mar. 25, 2020.
(60) Provisional application No. 62/905,373, filed on Sep. 24, 2019.

(51) Int. Cl. H01R 24/54; H01R 13/627; H01R 13/11

(52) U.S. Cl. CPC H01R 24/542; H01R 2103/00; H01R 13/111; H01R 13/6271

(57) ABSTRACT

Connectors and connector assemblies for attaching connectors to one or more cables and/or conduits are disclosed. The disclosed connectors and methods may secure an outer surface of the cable (e.g., an outer jacket of a cable) or conduit. A connector, for example, may include a female port with a port body, having a first port end configured to mate with a male element, a second port end opposing the first port, and a neck disposed between the first port end and the second port end, wherein the second port end engages with a cable gripper element such that a gap for positing the outer conductor layer is formed between opposing surfaces of the second port end and a surface of the cable gripper element.

### CROSS-REFERENCE TO RELATED APPLICATIONS

This application claims the benefit of priority under 35 U.S.C. § 119 of U.S. Provisional Application Ser. No. 62/994,642, filed Mar. 25, 2020, and U.S. Provisional Application Ser. No. 62/905,373, filed Sep. 24, 2019, the contents of which are relied upon and incorporated herein by reference in their entirety.

### BACKGROUND

Coaxial cable connectors, such as F-connectors, are used to attach coaxial cables to another object such as an appliance or junction having a terminal adapted to engage the connector. For example, on one end, the F-connectors are often used to terminate a drop cable in a cable television system. The coaxial cable typically includes an inner conductor surrounded by a dielectric layer, which is in turn surrounded by a conductive grounding foil and/or a braid defining an outer conductive grounding sheath. The outer conductive grounding sheath is itself surrounded by a protective outer jacket. The F-connector is typically secured over a prepared end of the jacketed coaxial cable, allowing the end of the coaxial cable to be connected with a terminal block, such as by a threaded connection with a threaded terminal of a terminal block.

Crimp style F-connectors including a crimp sleeve as part of a connector body are known. A special radial crimping tool, having jaws that form a hexagon, is typically used to radially crimp the crimp sleeve around the outer jacket of the coaxial cable to secure the crimp style F-connector over the prepared end of the coaxial cable.

Another type of F-connector uses a radial compression sleeve to secure the F-connector over the prepared end of the cable. Rather than crimping a crimp sleeve radially toward the jacket of the coaxial cable, these F-connectors employ a plastic annular compression sleeve that is mounted inside of the F-connector. The compression sleeve includes an inner bore that is driven radially inwardly by a connector body when the annular compression sleeve is moved from a starting position to an ending position by means of an axial compression tool. The end of the coaxial cable is prepared by removing a portion of the outer braid and/or folding the outer braid back over the cable jacket. The F-connector itself is then inserted over the prepared end of the coaxial cable.

The step of flaring and folding the braided outer conductive grounding sheath over the outer jacket can be a time consuming and painstaking process. Further, small fragments of the outer braid may break off. These small fragments may cause electrical shorts in nearby electrical systems and/or enter the skin of cable installer.

On the opposing end of the F-Connector is an F-Type port used to couple the F-Connector to a corresponding male component, typically using threaded designs. While threaded designs offer many advantages, these designs can cause complications. Such complications include, but are not limited to, threads becoming broken, and threads not being matched correctly with mated components.

In view of the aforementioned complications and as well as other issues with prior connector designs, alternative connectors are desired.

### SUMMARY

Disclosed herein are coaxial cable connectors configured for connection on a first connector end to a male element, using F-type ports, having one or more snap-in features and connection to a second, opposing connector end to a coaxial cable, using braid positioning elements.

The designs of the coaxial cable connector components disclosed herein are such that the respective mating components are sufficiently mated but preferably without the use of tools. The connector components are also preferably mated such that the F-type female port is configured to be in its most rested state when fully assembled. The particular designs of the F-type female ports disclosed herein can be such that the female port is configured to mate with male elements having damaged threads.

To achieve consistent mating with male elements, the F-type female ports disclosed herein preferably have “snap” elements. As used herein the term “snap” refers to flexible engagement and disengagement with one or more surfaces that may or may not be curved or contoured. The snap element preferably includes one or more cut-out portions which enable at least one snap-in feature to have spring-like characteristics, and thus allow a push on F-connector to rest, flexibly engaged and upon removal, flexibly retract or disengage from a seated position.

The connector elements disclosed herein are also designed such that both new female ports and retrofitted, or existing female ports can be mated with male elements. The coaxial cable connector female ports are also configurable with known standards or designed for mating with existing components as well as non-standard components.

One aspect of the disclosure is directed to embodiments of an F-type female port, which includes a port outer body, having a first port end and a second port end, an interior cavity disposed between the first port end and the second port, and at least one interior snap element positioned within the interior cavity, wherein the at least one interior snap element comprises at least one snap-in feature having spring-like characteristics that allow the at least one interior snap element to flexibly and retractably engage with a male element upon mating of the male element with the F-type female port.

Another aspect of the disclosure is directed to embodiments of connector assemblies including a male element and an F-type female port mated with the male element. The F-type female port includes a port outer body, having a first port end and a second port end, an interior cavity disposed between the first port end and the second port, and at least one interior snap element positioned within the interior cavity, wherein the at least one interior snap element has at least one snap-in feature having spring-like characteristics that allow the at least one interior snap element to flexibly and retractably engage with a male element upon mating of the male element with the F-type female port.

Yet another aspect of the disclosure is directed to a coaxial cable assembly for connecting a coaxial cable to a connector. The cable includes an inner conductor, an insulator layer surrounding the inner conductor, an outer conductor layer surrounding the insulator layer and an outer jacket. The coaxial cable connector includes a cable gripper element; and a coaxial cable connector, with the connector including a female port with a port outer body and an interior cavity, the port outer body has a first port end configured to mate with a male element and a second port end opposing the first port. The second port end slopes upwardly for engagement with the cable gripper element such that a gap for positing the outer conductor layer is formed between opposing surfaces of the second port end and a surface of the cable gripper element. In addition, the at least one interior snap element is positioned within the interior cavity, and the at least one interior snap element has at least one snap-in feature having spring-like characteristics that allow the at least one interior snap element to flexibly and retractably engage with the male element upon mating of the male element with the female port.

Additional features and advantages will be set forth in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain the principles and operation of the various embodiments.

### BRIEF DESCRIPTION OF THE DRAWINGS

FIG. 1 is a cross-sectional view of a male element having damaged threads, and an F-type female port in accordance with embodiments disclosed herein;

FIG. 2 is a partial cross-sectional view of the male element of FIG. 1, having damaged threads, assembled with the F-Type female port of FIG. 1 in accordance with embodiments disclosed herein;

FIG. 3 is a cross-sectional view of a thread-less male element and an F-type female port in accordance with embodiments disclosed herein;

FIG. 4 is a cross-sectional view of the thread-less male element of FIG. 3 assembled with the F-type female port of FIG. 3 in accordance with embodiments disclosed herein;

FIGS. 5 and 6 are isometric views of connector assemblies, with each assembly including an exterior seal ring assembled with an F-type female port in accordance with embodiments disclosed herein;

FIG. 7A is a cross-sectional view of a coaxial connector assembly, including a coaxial cable connector, a cable gripper unit, and a coaxial cable prior to assembly and positioning of the braid outer conductor layer in accordance with embodiments disclosed herein;

FIG. 7B is a cross-sectional view of a coaxial connector assembly, including the or a cable connector, a cable gripper unit, and a coaxial cable prior to assembly and after positioning of the braid outer conductor layer over the cable gripper unit in accordance with embodiments disclosed herein;

FIGS. 7C and 7D are cross-sectional views of the coaxial cable connector, the cable gripper unit, and the coaxial cable shown in FIGS. 7A and 7B after assembly and positioning of the braid outer conductor layer over the cable gripper unit in accordance with embodiments disclosed herein;

FIG. 8 is a cross-sectional view of a coaxial cable connector, a cable gripper unit, and a coaxial cable after assembly and positioning of the braid outer conductor layer over the cable gripper unit in accordance with embodiments disclosed herein;

FIG. 9 is an exploded isometric view of another coaxial connector assembly in accordance with embodiments disclosed herein;

FIG. 10 is an exploded side view of the coaxial connector assembly shown in FIG. 9;

FIG. 11 is a side view of the coaxial connector assembly shown in FIG. 9;

FIG. 12 is a side cross-sectional view of the coaxial connector assembly shown in FIG. 9, taken with respect to a longitudinal axis centrally disposed within the connector assembly.

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the features and limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates are used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

Disclosed herein are various types of coaxial cable connectors configured for connection on a first connector end to a male element, using F-type ports, having one or more snap-in features and connection to a second, opposing connector end to a coaxial cable, using braid positioning elements.

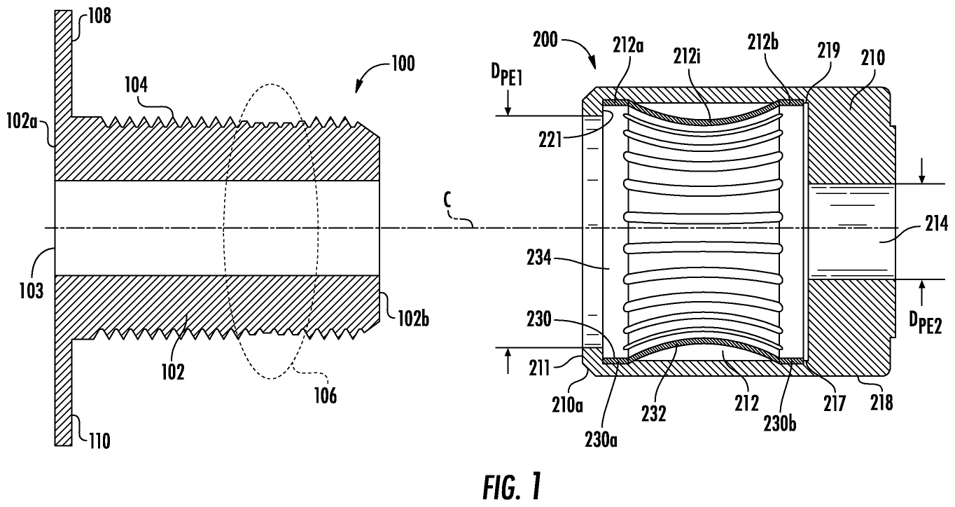

FIG. 1 shows cross-sectional views of a male element 100 and an F-type female port 200, which are substantially aligned with respect to a centerline C. The male element 100 includes a male element body 102, having a first body end 102a and a second body end 102b. A thru-hole 103 extends through the body 102, and threads 104 are circumferentially disposed around the body 102 with respect to the centerline C. The threads 104 include a damaged-thread section 106. However, in alternative embodiments, threads on the male connector may be free from damage. The body 102 also includes a front-end portion 108 having an extending section 110, which is substantially perpendicular to the body 102.

Still referring to FIG. 1, the F-type female port 200 is shown in substantial alignment with the male element 100 with respect to centerline C. The port 200 includes a port outer body 210, having a first port end 210a and a second port end 210b, and an interior cavity 212, having a first cavity end 212a and a second cavity end 212b. The port outer body 210 also has a substantially smooth outer surface 218. The port outer body 210, for example, may be made of metal such as brass and plated with a conductive material such as nickel.

The first port end 210a is defined, in part, by an inner diameter D_{PE1} such that the port end 210a has an inwardly extending step element 211. Similarly, the second port end 210b is defined, in part, by a bore 214. The bore 214 extends from the second cavity end 212b to the second port end 210b.

The interior cavity 212 extends from a step interior face 221 of the step element 211 to an opposing face 217 of an interior body element 219. The cavity 212 has a first cavity end 212a, an inner cavity section 212i, and a second cavity end 212b. The cavity 212 is configured to house an interior snap element 230 having at least one snap-in feature 232 with spring-like characteristics that allow the interior snap element 230 to flexibly engage and retractably engage with a male element upon mating of the male element 100 with the F-type female port 200.

The interior snap element 230 has a first snap element end 230a and a second snap element end 230b. The at least one snap-in feature 232 is preferably disposed between the first snap element end 230a and the second snap element end 230b. The spring-like characteristics of the at least one snap-in feature 232 can result from the properties of the materials used to manufacture the snap elements/snap-in features, e.g. steel, aluminum, and brass and various alloys that include steel, aluminum, and/or brass. Moreover, spring-like characteristics of the interior snap element 230 can result from one or more cut-out portions 234. A cut-out portion 234 in accordance with embodiments disclosed herein preferably extends along the length of the interior snap element 230. Where a plurality of cut-out portions 234 is included in the interior snap element 230, the plurality of cut-out portions 234 preferably is circumferentially and uniformly positioned around an inner surface of the interior snap element 230. The cut-out portions 234 are preferably uniformly positioned, as shown particularly in FIG. 1 and have a concave profile that inwardly curves toward the center of the port 200.

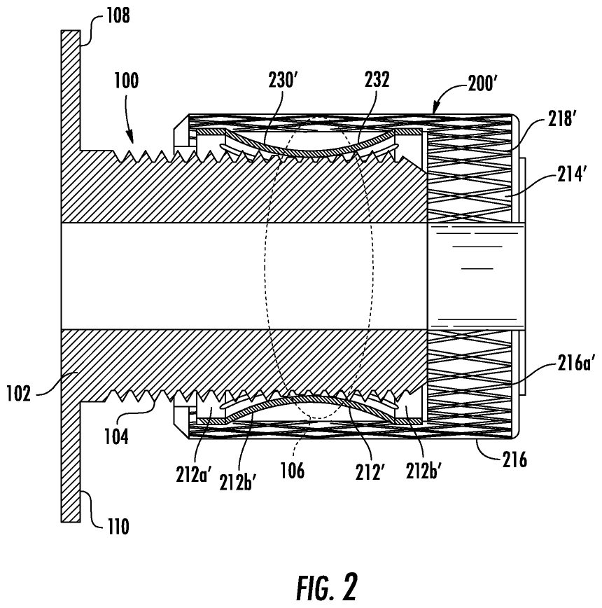

FIG. 2 is a partial cross-sectional view of the male element 100 assembled with an F-Type female port 200′. Here, an outer section 216′ is shown, having a knurled-pattern 216a′ on the outer surface 218′ of the port. The interior snap element 230′ is shown engaged with the damaged thread section 106 of the male element 100.

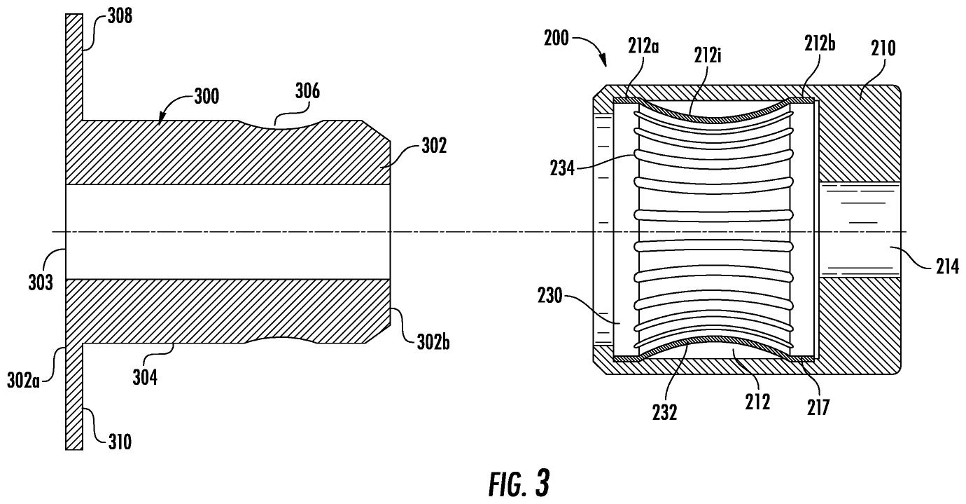

FIG. 3 is a cross-sectional view of a thread-less male element 300 and the F-type female port 200. The thread-less male element 300 has a thread-free body 302 with a thread-less section 306 having a curved profile 309 that inwardly curves toward the center of the male element 300. However, in alternative embodiments, the thread-less section 306 may not be included. The thread-less male element 300 also includes a first body end 302a and a second body end 302b. A thru-hole 303 extends through the body 302 and a front-end portion 308 having an extending section 310, which is substantially perpendicular to the body 302.

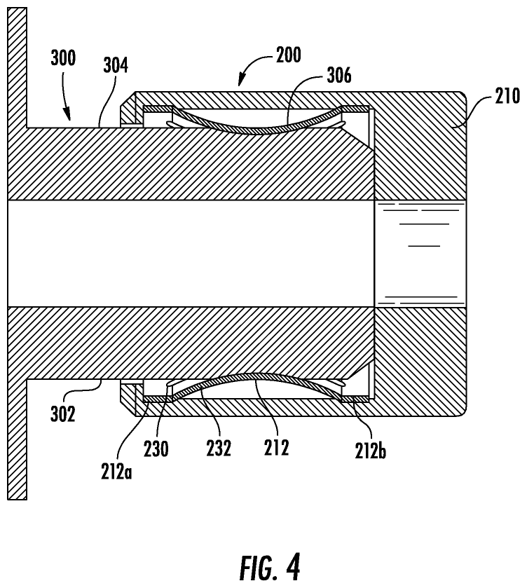

FIG. 4 is a cross-sectional view of the threadless male element 300 assembled with the F-type female port 200. Here, the at least one snap-in feature of the interior snap element 230 is in flexible and retractable engagement with a male element 300.

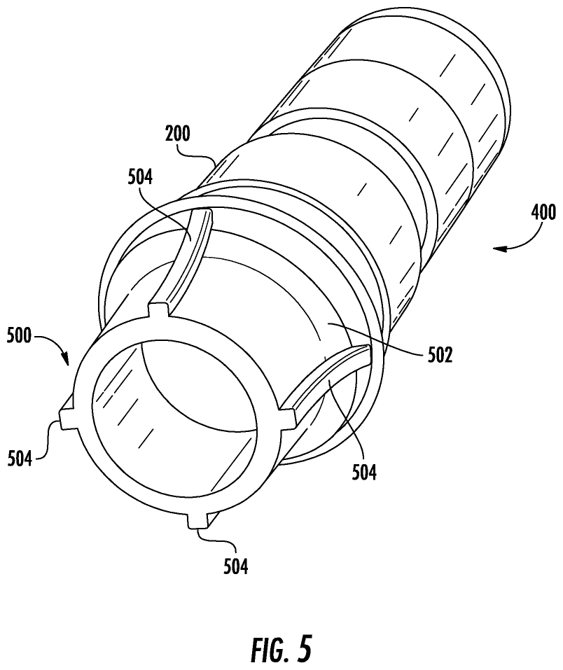

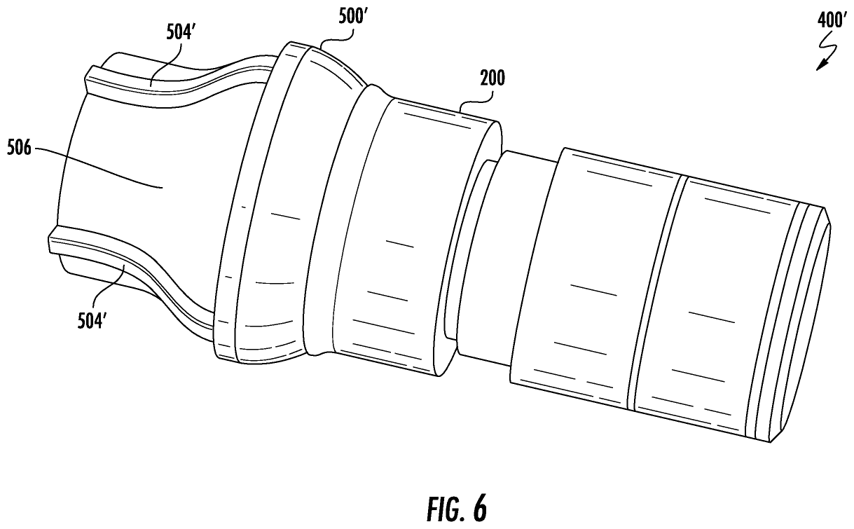

FIGS. 5-6 show connector assemblies 400, 400′, with each assembly including an exterior seal ring 500, 500′ assembled with an F-type female port 200, 200′. The seal rings 500, 500′ have different profiles with seal ring 500 having a concave outer surface 502 and a plurality of ribs 504 coupled to and uniformly positioned around the outer surface 502 and seal ring 500′ having a portion with a convex outer surface 502′ and a plurality of ribs 504′ coupled to and uniformly positioned around the outer surface 502′.

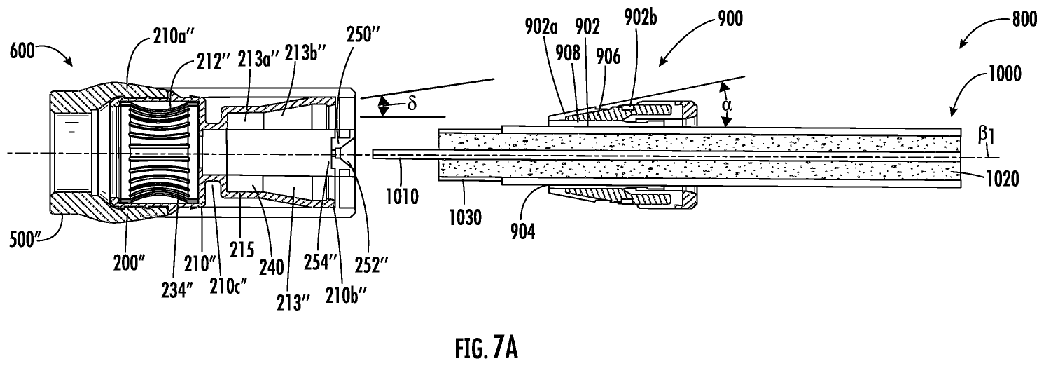

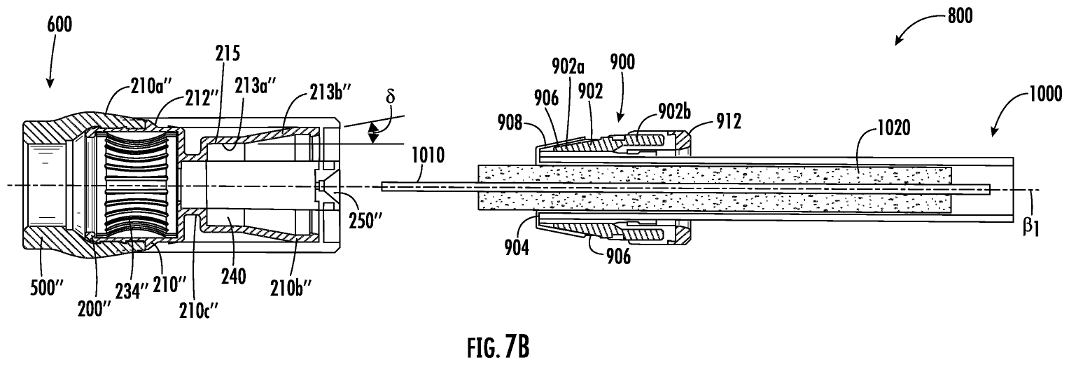

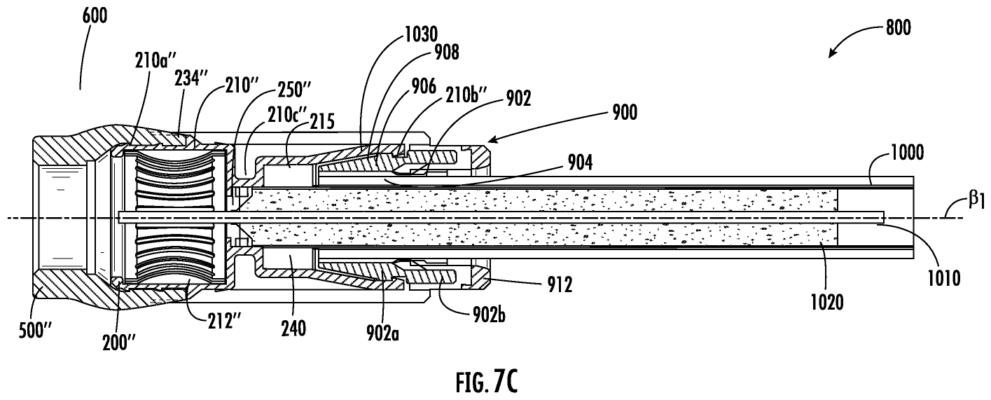

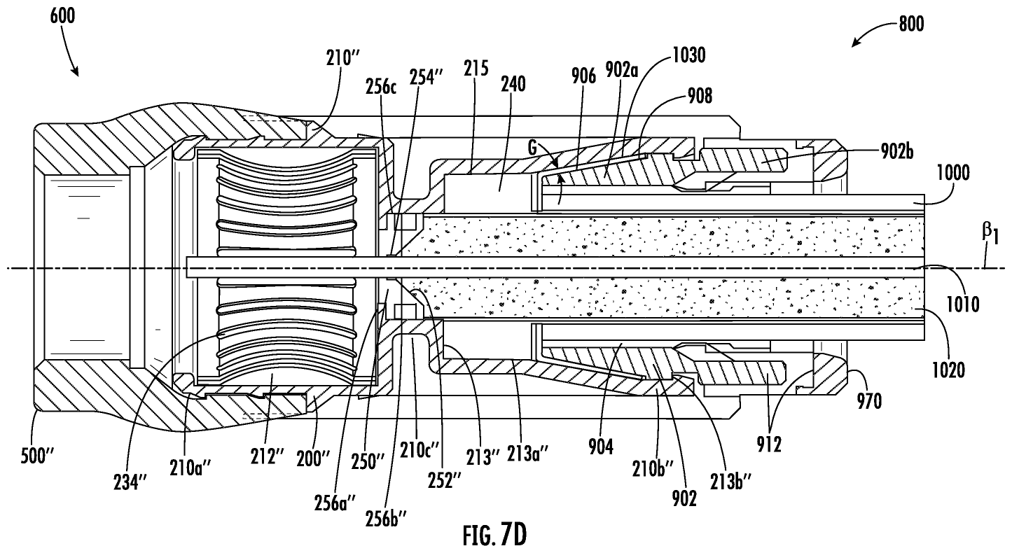

FIG. 7A is a cross-sectional view of a connector assembly 800, including a coaxial connector 600, a cable gripper unit 900, and a coaxial cable 1000 surrounded by the cable gripper unit 900. FIG. 7A particularly illustrates how each respective element in the connector assembly is positioned prior to assembly—with the exception of the cable gripper unit 900, which is positioned on the coaxial cable 1000.

The coaxial connector 600 includes an F-type female port 200″, with a port body 210″ including a first port end 210a″, a second port end 210b″ opposing the first port end, and a port neck 210c″ positioned between the first port end 210a″ and the second port end 210b″. Coupled to and surrounding the first port end 210a″ is an exterior seal ring 500″. Defined within the first port end 210a″ is an interior cavity 212″ configured to house an interior snap element 230″.

The interior snap element 230″ includes a first snap element end 230a″ and a second snap element end 230b″ with an at least one snap-in feature 232″ disposed therebetween. As with the additional embodiments of the interior snap element, the at least one snap-in feature 232″ has spring-like characteristics, which can result from the properties of the materials used to manufacture and/or the configuration(s) of one or more cut-out portions 234″ in the snap element 230″. A plurality of cut-out portions 234″ is preferably circumferentially and uniformly positioned with respect to an inner surface of the interior snap element 230 and have profiles that inwardly curve toward the center of the port 200″.

The second port end 210b″ also includes an interior bore 213″ defined by a first interior bore end 213a″ and a second interior bore end 213b″. Disposed within the first interior bore end 213a″ is a connector support sleeve 240. The first interior bore end 213a″ extends substantially parallel to a centrally located longitudinal axis β1. The second interior bore end 213b″ slopes upwardly at an angle δ (FIGS. 7B) measured with respect to a surface 215 of the first interior bore end 213a″, which is substantially parallel to longitudinal axis β1. Preferably, the angle measures from 0 to 90° (degrees). Here, the angle δ is about 15° to about 30°.

The coaxial cable 600 also includes an inner conductor seal 250″ configured to engage the inner conductor 1010 upon assembly. The inner conductor seal 250″ has a tapered inner bore 252″, and an opening 254″ having an inner diameter large enough to receive the inner conductor, as shown in FIG. 7C. As shown in FIG. 7D, The inner conductor seal 250″ has a stepped outer configuration, including outer diameters 256a″, 256b″ and an outer seal retainer 256c″, for positioning within the bore 220″ of the port neck 210c″.

FIGS. 7A-7C further illustrate an exemplary coaxial cable 1000 schematically illustrated in a partial cutaway view. The coaxial cable 1000 includes an inner conductor 1010 surrounded by an insulator layer 1020. In some embodiments the inner conductor 1010 is copper-clad aluminum, though the inner conductor 1010 may be a conductor other than copper-clad aluminum (e.g., copper, gold, or the like) in other embodiments. In some embodiments, the dielectric/insulator layer 1020 is a plastic, though the insulator layer 1020 may be an insulator other than plastic in other embodiments. The insulator layer 1020 may also have a foil or other metallic covering (not shown).

The coaxial cable 1000 further includes a braided outer conductor layer 1030 which may also be covered and protected by an outer layer (not shown) such as a cable jacket. In some embodiments, the covering and the braided outer conductor layer 1030 are aluminum, though the covering and/or the outer conductor layer may be a conductor other than aluminum in other embodiments. In some embodiments, the outer jacket is an insulator, such as, but not limited to plastic. The outer jacket may comprise, for example, polyethylene and/or other plastic.

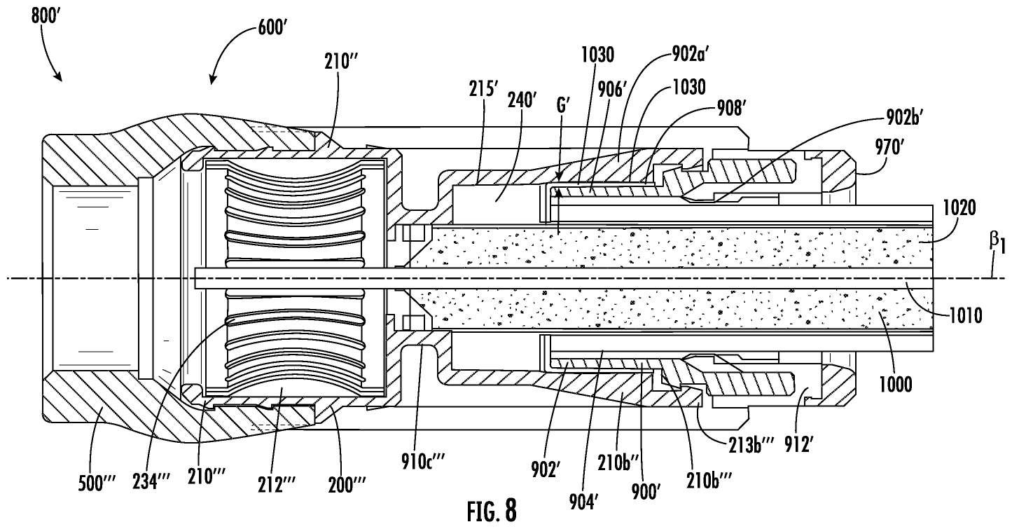

Folding back of a braided outer conductor is part of the current state of the art for cable preparation methods. The step of flaring and folding the braided outer conductive grounding sheath over the outer jacket can be a time consuming and painstaking process. Further, small fragments of the outer braid may break off. These small fragments may cause electrical shorts in nearby electrical systems and/or enter the skin of a cable installer. As a result, embodiments of coaxial cable connectors described herein may be installed on a cable prepared as illustrated in FIGS. 7A-7C, and FIG. 8, using cable gripper units, and eliminate the need to further prepare the cable, as used in prior art methods of cable preparation.

Referring to FIGS. 7A-7C, one version of the cable gripper unit 900 includes a front gripper element 902 and a rear gripper element 912 (see FIG. 7B). The front gripper element 902 has a first gripper portion 902a and second gripper portion 902b. The first gripper portion 902a has an inner bore 904 having a diameter sufficiently sized for the coaxial cable 1000 to rout through the inner bore 904. The first gripper portion 902a also has an outer positioning element 906 defined, in part, by an angle α measured with respect to an angled surface 908 of the outer positioning element 906 and a surface 911, which is parallel to longitudinal axis β2. Preferably, the angle measures from 0 to 90° (degrees). Here, the angle α is about 15° to about 30°. The rear gripper element 912 preferably includes an outer rear gripper surface 914 with a surface roughness or pattern that facilitates gripping, e.g. a knurled surface.

As shown particularly in FIGS. 7B-7C, the outer positioning element 906 is configured such that the braided outer conductor layer 1040 is subsequently folded and angularly coupled with the second interior bore end 213b″and with the braided outer conductor layer 1030 positioned therebetween. Specifically, the opposing angled surface 215 of the second interior bore end 213b″and the angled surface 908 of the outer positioning element 906 together define a gap G (FIG. D) configured to receive and engage an outer conductor layer (e.g., braided outer conductor layer 1030). The second gripper portion 902b is configured to couple with the rear gripper element 912 preferably via a mechanical engagement, e.g. a press-fit engagement.

FIG. 8 is a cross-sectional view of a connector assembly 800′, including a coaxial connector 600′, a cable gripper unit 900′, and the coaxial cable 1000 surrounded by the cable gripper unit 900′. As with the first embodiment disclosed herein, the coaxial connector 600′ includes an F-type female port 200′″, with a port body 210′″ including a first port end 210a′″, a second port end 210b′″, and a port neck 210c′″. Coupled to and surrounding the first port end 210a′″ is an exterior seal ring 500′″. And defined within the first port end 210a′″ is an interior cavity 212′″ configured to house an interior snap element 230′″.

The interior snap element 230′″ includes a first snap element end 230a′″ and a second snap element end 230b′″ with an at least one snap-in feature 232′″ disposed therebetween. The at least one snap-in feature 232′″ has spring-like characteristics, which can result from the properties of the materials used to manufacture and/or the configuration(s) of one or more cut-out portions 234′″ in the snap element 230′″. A plurality of cut-out portions 234′″ is preferably circumferentially and uniformly positioned with respect to an inner surface of the interior snap element 230′ and have profiles that inwardly curve toward the center of the port 200′″.

The second port end 210b′″ also includes an interior bore 213′″ defined by a first interior bore end 213a′″ and a second interior bore end 213b′″. Disposed within the first interior bore end 213a′″ is a connector support sleeve 240′. The first interior bore end 213a′″ extends substantially parallel to a centrally located longitudinal axis β1. The second interior bore end 213b′″ does not slope upwardly. Rather, the interior bore end 213b′″ is substantially flat with an angle of about 0° (degrees) and this substantially parallel with the longitudinal axis β′.

The cable gripper unit 900′ includes a front gripper element 902′ and a rear gripper element 912′. The front gripper element 902′ has a first gripper portion 902a′ and second gripper portion 902b′. The first gripper portion 902a′ has an inner bore 904′ having a diameter sufficiently sized for the coaxial cable 1000 to rout through the inner bore 904′. The first gripper portion 902a′ has an outer positioning element 906′ which is substantially parallel to the longitudinal axis δ′. The rear gripper element 912′ also preferably includes an outer rear gripper surface 914′ that facilitates gripping, e.g. a knurled surface.

The outer positioning element 906′ is configured such that the braided outer conductor layer 1040 is subsequently folded and angularly coupled with the second interior bore end 213b′″ with the braided outer conductor layer 1030 positioned therebetween. Specifically, the opposing surface 215′ of the second interior bore end 213b′″ and surface 908′ of the outer positioning element 906′ define a gap G′ configured to receive and engage the outer conductor layer (e.g., braided outer conductor layer 1030). The second gripper portion 902b′ is configured to couple with the rear gripper element 912′ preferably via a mechanical engagement, e.g. a press-fit engagement.

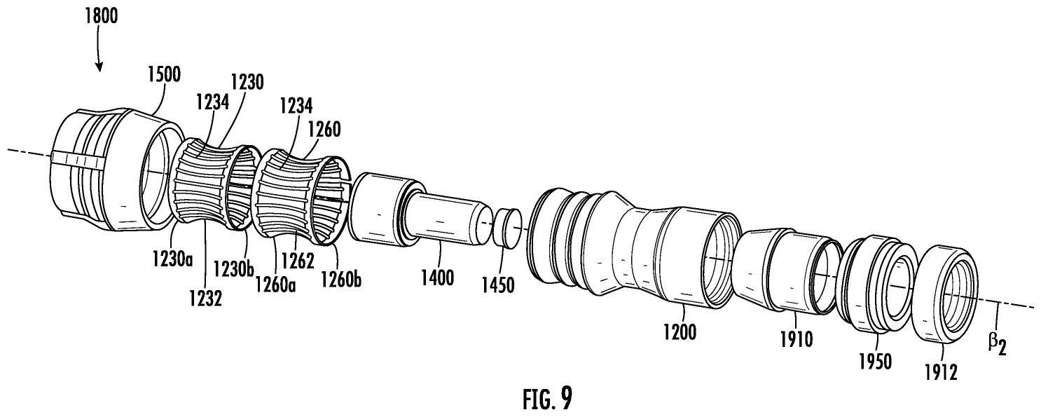

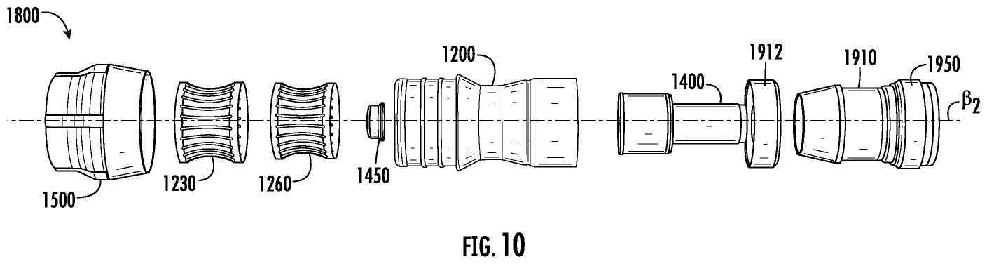

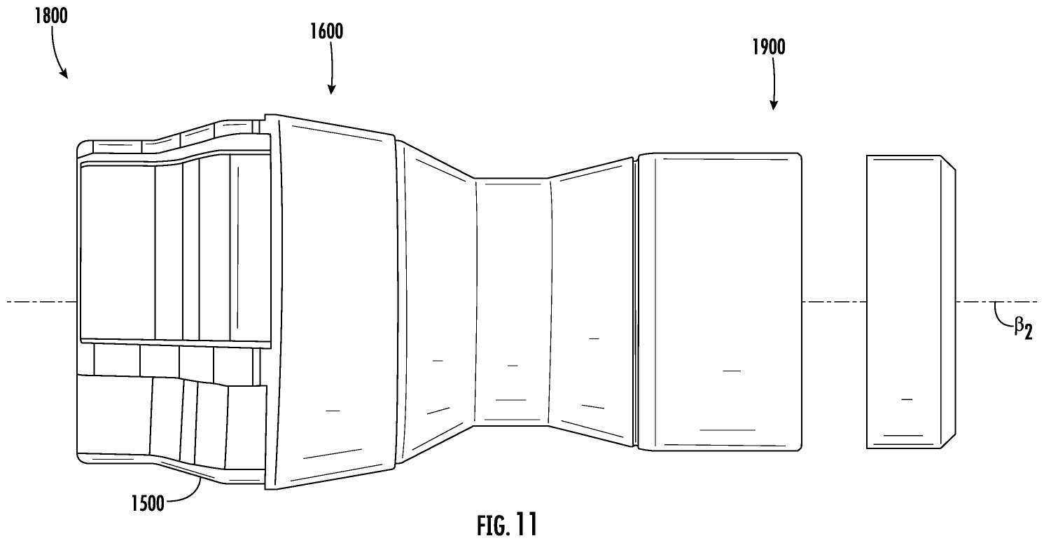

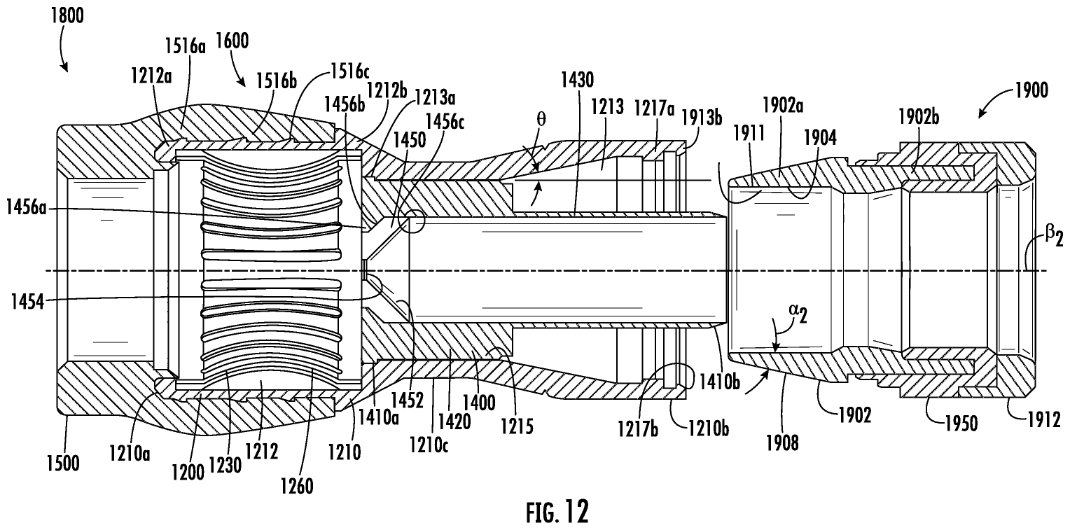

FIGS. 9-12 show various views of a coaxial connector assembly 1800, including a coaxial connector 1600 and a cable gripper unit 1900. Referring particularly to FIG. 12, the coaxial connector 1600 includes an F-type female port 1200, with a port body 1210, including a first port end 1210a, a second port end 1210b opposing the first port end 1210a, and a port neck 1210c positioned between the first port end 1210a and the second port end 1210b. The port body 1210, upon complete assembly of the connector 1800 with the cable gripper unit 1900, is configured to contain the interior snap elements 1230, 1260, a connector insert 1400, an inner conductor seal 1450, and a portion of the cable gripper unit 1900.

Coupled to and surrounding the first port end 1210a is an exterior seal ring 1500. The seal ring is preferably removal and coupled to the body 1210, using annular retaining members 1516a, 1516b, 1516c.

Defined within the first port end 1210a of the port body 1210 is an interior cavity 1212, having cavity ends 1212a, 1212b, configured to house the two interior snap elements 1230, 1260. Each interior snap element 1230, 1260 includes a first snap element end 1230a, 1260a and a second snap element end 1230b, 1260b with an at least one snap-in feature 1232, 1262 therebetween. Each snap-in feature 1232, 1262 has spring-like characteristics, which can result from the properties of the materials used to manufacture and/or the configuration(s) of one or more cut-out portions 1234, 1264. When a plurality of cut-out portions is included, as shown in FIG. 9, the cut-out portions are preferably circumferentially and uniformly positioned with respect to a centrally located longitudinal axis β2 that extends through each snap element. Each interior snap element also preferably includes curved profiles that inwardly curve toward the center of the port 1200. In this embodiment of the connector 1600, one of the interior snap elements is stacked such that one interior snap element is inserted into another. Accordingly, the interior snap elements are preferably stackable and can include more than two, depending upon the snap element, the connector size, and the dimensional constraints of the interior cavity of the port.

Referring to FIG. 12, the second port end 1210b also includes an interior bore 1213 defined by a first interior bore end 1213a and a second interior bore end 1213b. Disposed within the first interior bore end 1213a is the connector insert 1400 and an inner connector seal 1450. The first interior bore end 1213a extends substantially parallel to the longitudinal axis β2. The second interior bore end 1213b slopes upwardly at an angle ϕ (FIG. 12) measured with respect to a surface 1215 of the first interior bore end 1213a, which is substantially parallel to longitudinal axis β2. Preferably, the angle ϕ measures from about 0° to about 90° (degrees). Here, the angle ϕ is about 15° to about 30°. To prevent ingress of elements outside of the connector, the second port end 1210b also preferably includes inwardly extending lips 1217a, 1217b.

The connector insert 1400 acts as a guide and stop for the inner conductor seal 1450. The connector insert also acts as a secondary conductive contact within the connector assembly. The connector insert 1400 preferably has an elongated insert body 1410, with a first insert body 1410a end and a second insert body 1410b end opposing the first insert body end. The connector insert 1400 also includes a sleeve portion 1420 and a cylindrical insert portion 1430. The sleeve portion 1450 has an outside diameter configured for positioning within the port body 1210.

Still referring to FIG. 12, the cable gripper unit 1900 includes a front gripper element 1902 and a rear gripper element 1912. The front gripper element 1902 has a first gripper portion 1902a and second gripper portion 1902b. The first gripper portion 1902a has an inner bore 1904 having a diameter sufficiently sized for the coaxial cable 1000 (FIGS. 7A-7D) to route through the inner bore 1904. The first gripper portion 1902a also has an outer positioning element 1906 defined, in part, by an angle α2 measured with respect to an angled surface 1908 of the outer positioning element 1906 and a surface 1911, which is parallel to longitudinal axis β2. Preferably, the angle measures from about 0° to about 90° (degrees). Here, the angle α is about 15° to about 30°. The rear gripper element 1912 preferably includes an outer rear gripper surface 1914 with a surface roughness or pattern that facilitates gripping, e.g. a knurled surface, within the aft seal 1950.

The aft seal 1950, in addition to providing sealing, is configured to provide electrical isolation and facilitate positioning of the cable, upon insertion. The aft seal 1950 includes a seal body 1952 with a u-shaped channel 1954 disposed therein. The channel is shaped to receive the second gripper portion 1902b. The seal body 1952 also includes stepped outer surfaces 1956a, 1956b, 1956c, with the latter surface 1956c being configured to engage with the rear gripper element 1912. The rear gripper element 1912 preferably includes an outer rear gripper surface 1914 with a surface roughness or pattern that facilitates gripping, e.g. a knurled surface, and an inner face 1916 configured to engage with the aft seal 1950. This engagement is such that the rear gripper element 1912 acts as a pressure plate that distributes pressure on the end of the cable gripper unit 1900.

It should now be understood that embodiments described herein are directed to connectors and connector assemblies for securing an outer layer of a cable or conduit within a connector.

For the purposes of describing and defining the subject matter of the disclosure it is noted that the terms “substantially” and “generally” are utilized herein to represent the inherent degree of uncertainty that may be attributed to any quantitative comparison, value, measurement, or other representation.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

What is claimed is:

1. A coaxial connector assembly for connecting a coaxial cable comprising an inner conductor, an insulator layer surrounding the inner conductor, an outer conductor layer surrounding the insulator layer and an outer jacket, the coaxial cable connector comprising:
a female port, including a port outer body and an interior cavity, the port outer body having a first port end configured to mate with a male element and a second port end opposing the first port,
wherein the second port end slopes upwardly for engagement with a cable gripper element such that a gap for positing the outer conductor layer is formed between opposing surfaces of the second port end and a surface of the cable gripper element,
wherein at least one interior snap element is positioned within the interior cavity, and wherein the at least one interior snap element comprises at least one snap-in feature having spring-like characteristics, allowing the at least one interior snap element to flexibly and retractably engage with the male element upon mating of the male element with the female port.

2. The coaxial cable connector of claim 1, wherein the cable gripping member is adapted to secure the outer jacket of the coaxial cable.

3. The coaxial cable connector of claim 1, wherein the female port further comprises a neck disposed between the first port end and the second port end.

4. The coaxial cable connector of claim 1, wherein the at least one interior snap element incudes one or more cut-out portions.

5. The coaxial cable of claim 1, wherein the second port end slopes upwardly at an angle ranging from about 0 degrees to about 90 degrees.

6. The coaxial cable connector of claim 1, wherein the female port is configured for engagement with a thread-less male element.

7. The coaxial cable connector of claim 1, further comprising an exterior seal ring coupled to the port outer body.

8. The coaxial cable connector of claim 1, further comprising a plurality of cut-out portions uniformly positioned around the coaxial cable connector with respect to a centrally located longitudinal axis.

9. The coaxial cable connector of claim 1, further comprising a connector support sleeve disposed within the second port end.

10. The coaxial cable connector of claim 9, wherein the at least one of the one or more cut-out portions have a concave profile.

11. A coaxial cable assembly for connecting a coaxial cable to a coaxial cable connector, the cable comprising an inner conductor, an insulator layer surrounding the inner conductor, an outer conductor layer surrounding the insulator layer and an outer jacket, the coaxial cable connector comprising:
a cable gripper element; and
a coaxial cable connector, comprising:
a female port, including a port outer body and an interior cavity, the port outer body having a first port end configured to mate with a male element and a second port end opposing the first port,
wherein the second port end slopes upwardly for engagement with the cable gripper element such that a gap for positing the outer conductor layer is formed between opposing surfaces of the second port end and a surface of the cable gripper element, wherein at least one interior snap element is positioned within the interior cavity, and wherein the at least one interior snap element comprises at least one snap-in feature having spring-like characteristics that allow the at least one interior snap element to flexibly and retractably engage with the male element upon mating of the male element with the female port.

12. The coaxial cable assembly of claim 11, wherein the at least one interior snap element comprises a first snap element end and a second snap element end, and wherein the at least one snap-in feature is positioned between the first snap element end and the second snap element end.

13. The coaxial cable assembly of claim 11, wherein the at least one interior snap element comprises at least one cut-out portion extending along the length of the at least one snap-in feature.

14. The coaxial cable assembly of claim 11, wherein the at least one interior snap element comprises a plurality of cut-out portions positioned circumferentially around an inner surface of the at least one interior snap element.

15. The coaxial cable assembly of claim 11, wherein the interior cavity comprises a first cavity end and a second cavity end.

16. The coaxial cable assembly of claim 15, wherein the port outer body comprises an inwardly extending step element adjacent to the first cavity end.

17. The coaxial cable assembly of claim 15, wherein the port outer body includes a bore extending from the second cavity end to the second port end.

18. The coaxial cable assembly of claim 13, wherein the at least one cut-out portion inwardly curves toward the center of the female port.

19. The coaxial cable assembly of claim 11, wherein the port outer body has an outer surface with a knurled pattern.

20. The coaxial cable assembly of claim 11, wherein the port outer body has a substantially smooth outer surface.
